(19) United States
(12) Patent Application Publication
(10) Pub. No.: US 2021/0323380 A1
(43) Pub. Date: Oct. 21, 2021

(54) VEHICLE AIR CONDITIONER

(71) Applicant: SANDEN AUTOMOTIVE CLIMATE SYSTEMS CORPORATION, Gunma (JP)

(72) Inventors: Tetsuya ISHIZEKI, Gunma (JP); Takefumi TOMIYA, Gunma (JP); Yoshiyuki OKAMOTO, Gunma (JP); Takayuki MATSUMURA, Gunma (JP)

(21) Appl. No.: 17/273,017

(22) PCT Filed: Sep. 13, 2019
(86) PCT No.: PCT/JP2019/036221

§ 371 Date: Mar. 3, 2021

(30) Foreign Application Priority Data
Sep. 27, 2018 (JP) 2018-181778

(51) Int. Cl. B60H 1/03; B60H 1/00; B60H 1/32

(52) U.S. Cl. CPC B60H 1/03; B60H 1/00007; B60H 1/00328; B60H 1/3223; B60H 1/00457; B60H 1/3228; B60H 1/00342

(57) ABSTRACT

An object of the present invention is to provide a vehicle air conditioning device that can solve the decrease of a circulation refrigerant quantity while effectively using the heat of a temperature control object in heating a cabin. The heating operation of a vehicle air conditioning device (1) includes an external air heat absorption heating mode for heating a cabin in a manner that a refrigerant discharged from a compressor (2) radiates heat in a radiator (4), the refrigerant is decompressed, and then the refrigerant absorbs heat in an outdoor heat exchanger (7), and a temperature control object heat absorption heating mode for heating the cabin in a manner that the refrigerant absorbs heat in a refrigerant-heat medium heat exchanger (64), and these modes are performed while being switched. The heating operation is started in the external air heat absorption heating mode.

### TECHNICAL FIELD

The present invention relates to a heat pump type vehicle air conditioning device, particularly to a heat pump type vehicle air conditioning device capable of heating a cabin of a vehicle by absorbing heat from a temperature control object such as a battery mounted in the vehicle.

### BACKGROUND ART

In view of the environment problems that have become apparent recently, hybrid vehicles or electric vehicles in which a travel motor is driven by electric power supplied from a battery have been widely used. One of the developed air conditioning devices that are usable in such vehicles includes a refrigerant circuit in which a compressor that compresses a refrigerant and discharges the refrigerant, a radiator (indoor heat exchanger) that is provided inside a cabin of the vehicle and causes the refrigerant to radiate heat, and an outdoor heat exchanger that is provided outside the cabin, lets external air flow therethrough, and causes the refrigerant to absorb heat or radiate heat are connected. This air conditioning device performs a heating mode (heating operation) that causes the refrigerant discharged from the compressor to radiate heat in the radiator and causes the refrigerant having radiated heat in this radiator to absorb heat in the outdoor heat exchanger (for example, see Patent Literature 1).

On the other hand, a battery mounted in a vehicle generates heat from itself during charging or discharging, and therefore has high temperature. Performing the charging or discharging in such a state causes deterioration, which results in an operation failure and damage. In view of this, development has been conducted so that the temperature of a secondary battery (battery) can be adjusted in a manner that the air (heat medium) cooled by a refrigerant circulating in a refrigerant circuit is circulated in the battery (for example, see Patent Literature 2).

### CITATION LIST

### Patent Literature

Patent Literature 1: JP-A-2014-213765

Patent Literature 2: JP-A-2016-90201

### SUMMARY OF THE INVENTION

### Problems to be Solved by the Invention

Here, a temperature control object heat exchanger for cooling a temperature control object that is mounted in a vehicle, such as a battery, by using a refrigerant is provided in a refrigerant circuit and in this temperature control object heat exchanger, the refrigerant absorbs heat from the temperature control object (such as battery) either directly or indirectly (through heat medium), and this heat is sent to the radiator so that the cabin is heated. In this manner, the frosting of the outdoor heat exchanger can be suppressed and the heating operation time can be extended.

However, in a case of performing operation of causing the refrigerant to absorb heat only in the temperature control object heat exchanger, the refrigerant does not flow in the outdoor heat exchanger and the refrigerant flows only in the temperature control object heat exchanger. In this case, the sucking pressure of the compressor is higher than the saturation pressure of external air due to the influence of the temperature of the temperature control object.

That is to say, since the pressure in a region of the refrigerant circuit including the inside of the outdoor heat exchanger is lower than the sucking pressure of the compressor during the operation of causing the refrigerant to absorb heat only in the temperature control object heat exchanger (higher than the saturation pressure of the external air), if the refrigerant remains in the region of the refrigerant circuit including the inside of the outdoor heat exchanger, this remaining refrigerant cannot be collected in a refrigerant circulation region of the refrigerant circuit including the compressor and the circulation refrigerant quantity decreases, so that the sufficient heating performance cannot be exhibited, which is a problem.

The present invention has been made in order to solve the aforementioned conventional technical problem, and an object is to provide a vehicle air conditioning device that can solve the decrease of the circulation refrigerant quantity while effectively using the heat of the temperature control object in heating the cabin.

### Solution to the Problems

A vehicle air conditioning device of the invention according to claim 1 is for performing air conditioning in a cabin, the vehicle air conditioning device including: a compressor that compresses a refrigerant; an indoor heat exchanger that performs heat exchange between air to be supplied into the cabin and the refrigerant; an outdoor heat exchanger that is provided outside the cabin; a control device; and a temperature control object heat exchanger that adjusts temperature of a temperature control object mounted in a vehicle by using the refrigerant, wherein the control device performs heating operation for heating the cabin using the indoor heat exchanger, the heating operation includes an external air heat absorption heating mode for heating the cabin in a manner that the refrigerant discharged from the compressor radiates heat in the indoor heat exchanger, the refrigerant having radiated heat is decompressed, and then the refrigerant absorbs heat in the outdoor heat exchanger, and a temperature control object heat absorption heating mode for heating the cabin in a manner that the refrigerant discharged from the compressor radiates heat in the indoor heat exchanger, the refrigerant having radiated heat is decompressed, and then the refrigerant absorbs heat in the temperature control object heat exchanger and these modes are performed while being switched, and the heating operation is started in the external air heat absorption heating mode.

The vehicle air conditioning device of the invention according to claim 2 is the vehicle air conditioning device in the aforementioned invention wherein in the heating operation, the control device further performs a combination heating mode for heating the cabin in a manner that the refrigerant discharged from the compressor radiates heat in the indoor heat exchanger, the refrigerant having radiated heat is decompressed, and then the refrigerant absorbs heat in the outdoor heat exchanger and the temperature control object heat exchanger, and the control device performs the heating operation while switching among the external air heat absorption heating mode, the combination heating mode, and the temperature control object heat absorption heating mode, and the heating operation is started in the external air heat absorption heating mode or the combination heating mode.

A vehicle air conditioning device of the invention according to claim 3 is for performing air conditioning in a cabin, the vehicle air conditioning device including: a compressor that compresses a refrigerant; an indoor heat exchanger that performs heat exchange between air to be supplied into the cabin and the refrigerant; an outdoor heat exchanger that is provided outside the cabin; a control device; and a temperature control object heat exchanger that adjusts temperature of a temperature control object mounted in a vehicle by using the refrigerant, wherein the control device performs heating operation for heating the cabin using the indoor heat exchanger, the heating operation includes a temperature control object heat absorption heating mode for heating the cabin in a manner that the refrigerant discharged from the compressor radiates heat in the indoor heat exchanger, the refrigerant having radiated heat is decompressed, and then the refrigerant absorbs heat in the temperature control object heat exchanger, and a combination heating mode for heating the cabin in a manner that the refrigerant discharged from the compressor radiates heat in the indoor heat exchanger, the refrigerant having radiated heat is decompressed, and then the refrigerant absorbs heat in the outdoor heat exchanger and the temperature control object heat exchanger, and these modes are performed while being switched, and the heating operation is started in the combination heating mode.

The vehicle air conditioning device of the invention according to claim 4 is the vehicle air conditioning device in each aspect of the aforementioned invention, wherein the control device performs the heating operation while switching the respective modes based on a request temperature control object cooling capability requested for the temperature control object heat exchanger.

The vehicle air conditioning device of the invention according to claim 5 is the vehicle air conditioning device in each aspect of the aforementioned invention, wherein in a case where a predetermined starting condition is satisfied after the operation starts in the external air heat absorption heating mode, the external air heat absorption heating mode or the combination heating mode, or the combination heating mode, the control device performs any of the modes selected based on the request temperature control object cooling capability.

The vehicle air conditioning device of the invention according to claim 6 is the vehicle air conditioning device in each aspect of the aforementioned invention, wherein the starting condition is one of the following conditions, a combination of the following conditions, or all of the following conditions: a predetermined time has elapsed after start, a refrigerant sucking pressure of the compressor has decreased to be lower than or equal to a predetermined value and a predetermined time has elapsed, refrigerant sucking temperature of the compressor has decreased to be lower than or equal to a predetermined value and a predetermined time has elapsed.

### Effects of the Invention

The invention according to claim 1 provides the vehicle air conditioning device for performing air conditioning in a cabin, the vehicle air conditioning device including: a compressor that compresses a refrigerant; an indoor heat exchanger that performs heat exchange between air to be supplied into the cabin and the refrigerant; an outdoor heat exchanger that is provided outside the cabin; a control device; and a temperature control object heat exchanger that adjusts temperature of a temperature control object mounted in a vehicle by using the refrigerant, wherein the control device performs heating operation for heating the cabin using the indoor heat exchanger, the heating operation includes an external air heat absorption heating mode for heating the cabin in a manner that the refrigerant discharged from the compressor radiates heat in the indoor heat exchanger, the refrigerant having radiated heat is decompressed, and then the refrigerant absorbs heat in the outdoor heat exchanger, and a temperature control object heat absorption heating mode for heating the cabin in a manner that the refrigerant discharged from the compressor radiates heat in the indoor heat exchanger, the refrigerant having radiated heat is decompressed, and then the refrigerant absorbs heat in the temperature control object heat exchanger and these modes are performed while being switched. In the case where the cabin is heated by the heat pumped from the external air in the external air heat absorption heating mode and for example, the temperature control object needs to be cooled and the cabin can be heated with the heat from the temperature control object, generally, heat is pumped from the temperature control object as the temperature control object heat absorption heating mode, and while the temperature control object is cooled, the cabin can be heated. In this manner, the cabin can be heated efficiently by effectively using the heat of the temperature control object, and while the frosting of the outdoor heat exchanger is suppressed, the temperature control object can be cooled properly.

In particular, at the start of the heating operation, the control device starts in the external air heat absorption heating mode; therefore, even when the refrigerant remains in the outdoor heat exchanger or the like, this remaining refrigerant can be collected by performing the external air heat absorption heating mode at the start. Thus, the inconvenience that the refrigerant remains in the outdoor heat exchanger or the like and the circulation refrigerant quantity in performing the temperature control object heat absorption heating mode decreases so that the heating capability deteriorates can be solved and accordingly, the operation range in the low-temperature environment can be expanded.

In the invention according to claim 2, in addition to the aforementioned invention, in the heating operation, the control device further performs a combination heating mode for heating the cabin in a manner that the refrigerant discharged from the compressor radiates heat in the indoor heat exchanger, the refrigerant having radiated heat is decompressed, and then the refrigerant absorbs heat in the outdoor heat exchanger and the temperature control object heat exchanger, and the control device performs the heating operation while switching among the external air heat absorption heating mode, the combination heating mode, and the temperature control object heat absorption heating mode. Therefore, when the heat generation from the temperature control object is relatively small, heat is pumped from the external air and the temperature control object by the combination heating mode, and while the temperature control object is cooled, the cabin can be heated without any trouble.

In this case, at the start in the heating operation, the control device starts the heating operation in the external air heat absorption heating mode or the combination heating mode; therefore, the refrigerant remaining in the outdoor heat exchanger or the like can be collected without any trouble at the start.

The vehicle air conditioning device of the invention according to claim 3 is for performing air conditioning in a cabin, the vehicle air conditioning device including: a compressor that compresses a refrigerant; an indoor heat exchanger that performs heat exchange between air to be supplied into the cabin and the refrigerant; an outdoor heat exchanger that is provided outside the cabin; a control device; and a temperature control object heat exchanger that adjusts temperature of a temperature control object mounted in a vehicle by using the refrigerant, wherein the control device performs heating operation for heating the cabin using the indoor heat exchanger, the heating operation includes a temperature control object heat absorption heating mode for heating the cabin in a manner that the refrigerant discharged from the compressor radiates heat in the indoor heat exchanger, the refrigerant having radiated heat is decompressed, and then the refrigerant absorbs heat in the temperature control object heat exchanger, and a combination heating mode for heating the cabin in a manner that the refrigerant discharged from the compressor radiates heat in the indoor heat exchanger, the refrigerant having radiated heat is decompressed, and then the refrigerant absorbs heat in the outdoor heat exchanger and the temperature control object heat exchanger, and these modes are performed while being switched. For example, when the cabin can be heated with the heat of the temperature control object, heat is pumped from the temperature control object as the temperature control object heat absorption heating mode and while the temperature control object is cooled, the cabin is heated. For example, when the heat generation from the temperature control object is relatively small, heat is pumped from the external air and the temperature control object by the combination heating mode, and while the temperature control object is cooled, the cabin can be heated without any trouble. Thus, the cabin can be heated efficiently by effectively using the heat of the temperature control object, and while the frosting of the outdoor heat exchanger is suppressed, the temperature control object can be cooled properly.

In particular, at the start of the heating operation, the control device starts the heating operation in the combination heating mode; therefore, even when the refrigerant remains in the outdoor heat exchanger or the like, the combination heating mode is performed at the start so that this remaining refrigerant can be collected. Accordingly, the inconvenience that the refrigerant remains in the outdoor heat exchanger or the like and the circulation refrigerant quantity in performing the temperature control object heat absorption heating mode decreases so that the heating capability deteriorates can be solved and accordingly, the operation range in the low-temperature environment can be expanded.

As described in the invention according to claim 4, the control device performs the heating operation while switching the respective modes based on a request temperature control object cooling capability requested for the temperature control object heat exchanger. Thus, both the heating of the cabin and the cooling of the temperature control object can be achieved as appropriate.

Additionally, as described in the invention according to claim 5, in a case where a predetermined starting condition is satisfied after the operation starts in the external air heat absorption heating mode or the combination heating mode, the control device performs any of the modes selected based on the request temperature control object cooling capability. Thus, the refrigerant remaining in the outdoor heat exchanger or the like can be collected at the start without any trouble, and then, the mode can smoothly shift to the suitable mode selected based on the request temperature control object cooling capability.

For example, as described in the invention according to claim 6, the starting condition is that a predetermined time has elapsed after start, a refrigerant sucking pressure of the compressor has decreased to be lower than or equal to a predetermined value and a predetermined time has elapsed, a refrigerant sucking temperature of the compressor has decreased to be lower than or equal to a predetermined value and a predetermined time has elapsed. Thus, after the refrigerant remaining in the outdoor heat exchanger or the like is collected for sure, the mode can shift to the suitable mode.

### BRIEF DESCRIPTION OF THE DRAWINGS

FIG. 1 is a structure diagram illustrating one example of a vehicle air conditioning device to which the present invention is applied.

FIG. 2 is a block diagram of an air conditioning controller as a control device of the vehicle air conditioning device illustrated in FIG. 1.

FIG. 3 is a diagram for describing heating operation (external air heat absorption heating mode) by the air conditioning controller in FIG. 2.

FIG. 4 is a diagram for describing dehumidifying and heating operation by the air conditioning controller in FIG. 2.

FIG. 5 is a diagram for describing internal cycle operation by the air conditioning controller in FIG. 2.

FIG. 6 is a diagram for describing dehumidifying and cooling operation/cooling operation by the air conditioning controller in FIG. 2.

FIG. 7 is a diagram for describing a combination heating mode in the heating operation by the air conditioning controller in FIG. 2.

FIG. 8 is a diagram for describing a temperature control object heat absorption heating mode in the heating operation by the air conditioning controller in FIG. 2.

FIG. 9 is a diagram for describing a cooling/temperature control object temperature adjustment mode by the air conditioning controller in FIG. 2.

FIG. 10 is a flowchart for describing control at the start in the heating operation by the air conditioning controller in FIG. 2.

### DESCRIPTION OF THE EMBODIMENTS

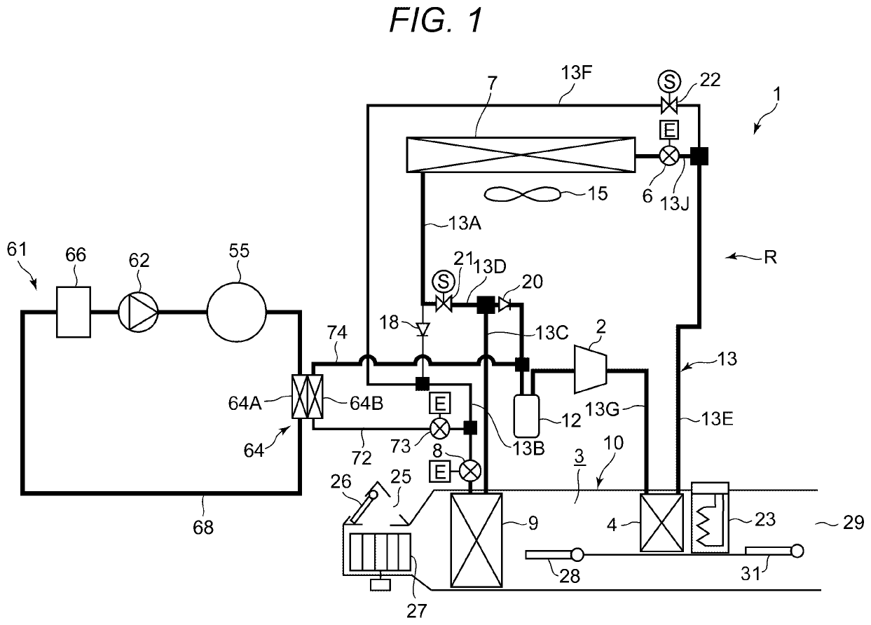

Embodiments of the present invention are hereinafter described in detail with reference to the drawings. FIG. 1 is a structure diagram illustrating a vehicle air conditioning device 1 according to one example to which the present invention is applied. A vehicle according to one example to which the present invention is applied is an electric vehicle (EV) without an engine (internal combustion engine), in which a battery 55 (for example, lithium battery) is mounted. The vehicle is driven to travel in a manner that electric power charged in the battery 55 from an external power source such as a quick charger is supplied to a travel motor (electric motor). Moreover, the vehicle air conditioning device 1 is also driven with the power supplied from the battery 55.

That is to say, in the electric vehicle that cannot perform heating with the waste heat from the engine, the vehicle air conditioning device 1 performs heating operation by heat pump operation using a refrigerant circuit R and moreover, performs air conditioning in the cabin by selectively performing air conditioning operation including dehumidifying and heating operation, internal cycle operation, dehumidifying and cooling operation, and cooling operation. Note that the present invention is applicable to not just the electric vehicle but also a so-called hybrid vehicle using both an engine and a travel motor.

The vehicle air conditioning device 1 according to the example is to perform air conditioning in the cabin of the electric vehicle (heating, cooling, dehumidifying, and ventilating), and an electric type compressor (electric compressor) 2 that compresses a refrigerant, a radiator 4 serving as an indoor heat exchanger that is provided in an air flow path 3 of an HVAC unit 10 where the air in the cabin passes and circulates, the refrigerant with high temperature and high pressure discharged from the compressor 2 flowing into the radiator 4 through a refrigerant pipe 13G, and causes this refrigerant to radiate heat (heat is emitted from the refrigerant) so as to heat the air to be supplied into the cabin, an outdoor expansion valve 6 including an electric valve that decompresses and expands the refrigerant in the heating, an outdoor heat exchanger 7 that performs heat exchange between the refrigerant and the external air in order to function as a radiator that causes the refrigerant to radiate heat in the cooling and function as an evaporator that causes the refrigerant to absorb heat (refrigerant absorbs heat) in the heating, an indoor expansion valve 8 including an electric valve that decompresses and expands the refrigerant, a heat sink 9 that is provided in the air flow path 3 and causes the refrigerant to absorb heat (refrigerant absorbs heat) from inside or outside the cabin in the cooling and the dehumidifying so as to cool the air to be supplied into the cabin, an accumulator 12, and the like are connected sequentially with a refrigerant pipe 13 and thus, the refrigerant circuit R is formed.

The outdoor expansion valve 6 and the indoor expansion valve 8 can decompress and expand the refrigerant and can also be fully opened or closed. Note that an outdoor fan 15 is provided to the outdoor heat exchanger 7. This outdoor fan 15 is configured to exchange heat between the external air and the refrigerant by forcibly blowing the external air into the outdoor heat exchanger 7 so that the external air is supplied to the outdoor heat exchanger 7 also when the vehicle stops (that is, vehicle speed is 0 km/h).

A refrigerant pipe 13A connected to a refrigerant outlet side of the outdoor heat exchanger 7 is connected to a refrigerant pipe 13B through a check valve 18. Note that a direction from the check valve 18 to the refrigerant pipe 13B is a forward direction, and this refrigerant pipe 13B is connected to the indoor expansion valve 8.

The refrigerant pipe 13A exiting from the outdoor heat exchanger 7 is branched, and this branched refrigerant pipe 13D communicates with and connects to a refrigerant pipe 13C that is positioned on an outlet side of the heat sink 9 through a solenoid valve 21 as an open/close valve that is opened in the heating. A check valve 20 is connected to the refrigerant pipe 13C on the downstream side of the connection point of the refrigerant pipe 13D, and the refrigerant pipe 13C on the downstream side of the check valve 20 is connected to the accumulator 12. The accumulator 12 is connected to a refrigerate suction side of the compressor 2. Note that a direction from the check valve 20 to the accumulator 12 is the forward direction.

Furthermore, a refrigerant pipe 13E on the refrigerant outlet side of the radiator 4 is branched into a refrigerant pipe 13J and a refrigerant pipe 13F before the outdoor expansion valve 6 (on the refrigerant upstream side), and one of the branched refrigerant pipes, the refrigerant pipe 13J, is connected to a refrigerant inlet side of the outdoor heat exchanger 7 through the outdoor expansion valve 6. The other one of the branched refrigerant pipes, the refrigerant pipe 13F, communicates with and connects to the refrigerant pipe 13B positioned on the refrigerant downstream side of the check valve 18 and on the refrigerant upstream side of the indoor expansion valve 8 through a solenoid valve 22 that is open in the dehumidifying.

Thus, the refrigerant pipe 13F is connected in parallel to a serial circuit of the outdoor expansion valve 6, the outdoor heat exchanger 7, and the check valve 18, and a circuit that bypasses the outdoor expansion valve 6, the outdoor heat exchanger 7, and the check valve 18 is formed.

In the air flow path 3 on the air upstream side of the heat sink 9, suction ports including an external air suction port and an internal air suction port are formed (in FIG. 1, represented by a suction port 25). In this suction port 25, a suction switch dumper 26 is provided. The suction switch dumper 26 switches the air to be introduced into the air flow path 3 between the internal air that is the air in the cabin (internal air circulation) and the external air that is the air outside the cabin (external air introduction). Furthermore, an indoor fan (blower fan) 27 is provided on the air downstream side of this suction switch dumper 26. The indoor fan 27 supplies the introduced internal air or external air to the air flow path 3.

In FIG. 1, a reference numeral 23 denotes an auxiliary heater as an auxiliary heating device. In this example, the auxiliary heater 23 is formed by a PTC heater (electric heater), and is provided in the air flow path 3 on the air downstream side of the radiator 4 with respect to the air flow in the air flow path 3. When electricity is supplied to the auxiliary heater 23 and heat is generated, this serves as a so-called heater core and assists to heat the cabin.

In the air flow path 3 on the air upstream side of the radiator 4, an air mix dumper 28 is provided. The air mix dumper 28 adjusts the ratio of the air that is supplied to the radiator 4 and the auxiliary heater 23 to the air (internal air or external air) that has flowed into the air flow path 3, has passed the heat sink 9, and exists in the air flow path 3. In addition, in the air flow path 3 on the air downstream side of the radiator 4, blowing ports of FOOT (foot), VENT (ventilation), and DEF (defrost) are formed (in FIG. 1, a blowing port 29 is illustrated as a representative). This blowing port 29 is provided with a blowing port switch dumper 31 that controls to switch the blowing of air from each port.

Moreover, the vehicle air conditioning device 1 includes an apparatus temperature adjustment device 61 that adjusts the temperature of the battery 55 by circulating a heat medium in the battery 55 (temperature control object). That is to say, the battery 55 is the temperature control object mounted in the vehicle in the example. Note that the temperature control object is not limited to the battery 55 in the example and refers to concept including heat generating apparatuses such as a travel motor and an inverter circuit for driving the motor.

The apparatus temperature adjustment device 61 according to the example includes a circulation pump 62 as a circulation device for circulating the heat medium in the battery 55, a heat medium heater 66 as a heating device, and a refrigerant-heat medium heat exchanger 64 as a temperature control object heat exchanger. These elements are connected to the battery 55 through a heat medium pipe 68.

In the case of this example, the inlet of the battery 55 is connected to the discharging side of the circulation pump 62, and to the outlet of the battery 55, the inlet of a heat medium flow path 64A of the refrigerant-heat medium heat exchanger 64 is connected. The outlet of this heat medium flow path 64A is connected to the inlet of the heat medium heater 66, and the outlet of the heat medium heater 66 is connected to the suction side of the circulation pump 62.

Examples of the heat medium used in this apparatus temperature adjustment device 61 include liquid such as water and coolant, a refrigerant such as HFO-1234yf, and gas such as air. In this example, water is used as the heat medium. In addition, the heat medium heater 66 is formed by an electric heater such as a PTC heater. Around the battery 55, for example, a jacket structure in which the heat medium can flow by the heat exchange relation with the battery 55 is formed.

Upon the start of the operation of the circulation pump 62, the heat medium discharged from the circulation pump 62 flows to the battery 55, where the heat medium exchanges heat with the battery 55. The heat medium having exchanged heat with the battery 55 then flows into the heat medium flow path 64A of the refrigerant-heat medium heat exchanger 64. The heat medium exiting from the heat medium flow path 64A of this refrigerant-heat medium heat exchanger 64 flows to the heat medium heater 66, and in the case where the heat medium heater 66 generates heat, the heat medium is heated there and then, is sucked in the circulation pump 62; thus, the heat medium circulates in the heat medium pipe 68.

On the other hand, one end of a branch pipe 72 as a branch circuit is connected to the refrigerant pipe 13B positioned on a refrigerant upstream side of the indoor expansion valve 8 and on a refrigerant downstream side of a connection portion between the refrigerant pipe 13B and the refrigerant pipe 13F in the refrigerant circuit R. This branch pipe 72 is provided with an auxiliary expansion valve 73 formed by an electric valve. This auxiliary expansion valve 73 can decompress and expand the refrigerant that flows in a refrigerant flow path 64B, which is described below, of the refrigerant-heat medium heat exchanger 64, and also be fully closed.

The other end of the branch pipe 72 is connected to the refrigerant flow path 64B of the refrigerant-heat medium heat exchanger 64. One end of a refrigerant pipe 74 is connected to the outlet of this refrigerant flow path 64B and the other end of the refrigerant pipe 74 is connected to the refrigerant pipe 13C on the refrigerant downstream side of the check valve 20 and before the accumulator 12 (refrigerant upstream side). These auxiliary expansion valve 73 and the like also constitute a part of the refrigerant circuit R, and at the same time constitute a part of the apparatus temperature adjustment device 61.

In a case where the auxiliary expansion valve 73 is open, the refrigerant (part of the refrigerant or the entire refrigerant) exiting from the refrigerant pipe 13F or the outdoor heat exchanger 7 flows in the branch pipe 27 and is decompressed at the auxiliary expansion valve 73. After that, the refrigerant flows in the refrigerant flow path 64B of the refrigerant-heat medium heat exchanger 64 and evaporates therefrom. The refrigerant absorbs heat from the heat medium flowing in the heat medium flow path 64A in the process of flowing in the refrigerant flow path 64B, and then is sucked into the compressor 2 through the accumulator 12.

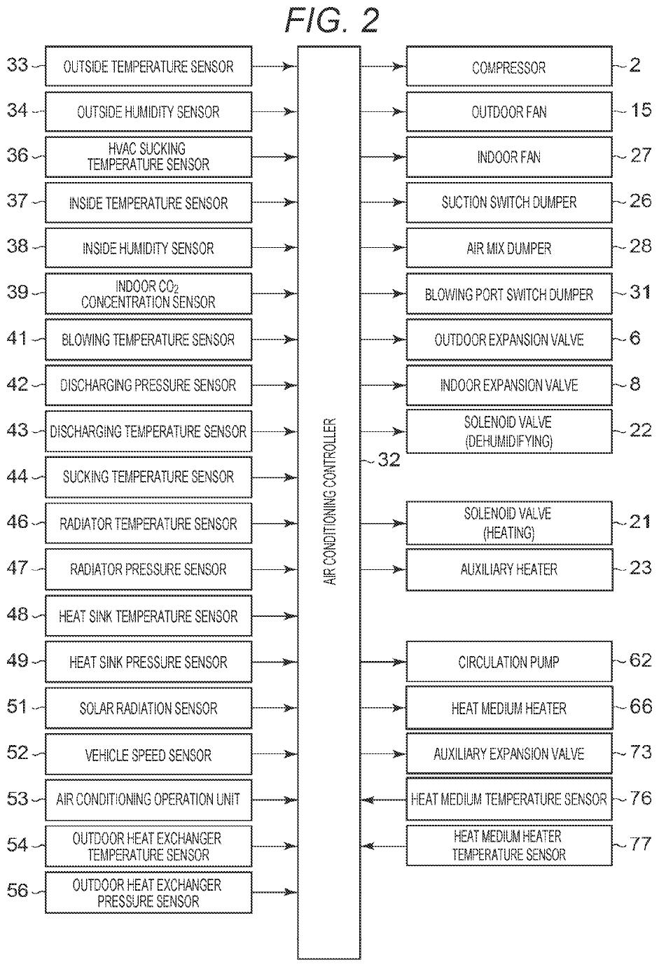

Next, in FIG. 2, a reference numeral 32 denotes an air conditioning controller that serves as a control device that controls the vehicle air conditioning device 1. The air conditioning controller 32 is formed by a microcomputer as one example of a computer including a processor.

To the input of the air conditioning controller 32 (control device), the output of each of the following elements is connected: an outside temperature sensor 33 that detects outside temperature (Tam) outside the vehicle, an outside humidity sensor 34 that detects outside humidity (Ham) outside the vehicle, an HVAC sucking temperature sensor 36 that detects the temperature of air that is sucked from the suction port 25 to the air flow path 3, an inside temperature sensor 37 that detects the temperature of the air (internal air) inside the cabin, an inside humidity sensor 38 that detects the humidity of the air inside the cabin, an indoor CO₂ concentration sensor 39 that detects the carbon dioxide concentration inside the cabin, a blowing temperature sensor 41 that detects the temperature of the air blown from the blowing port 29 into the cabin, a discharging pressure sensor 42 that detects discharging refrigerant pressure (discharging pressure Pd) of the compressor 2, a discharging temperature sensor 43 that detects the discharging refrigerant temperature of the compressor 2, a sucking temperature sensor 44 that detects the sucking refrigerant temperature of the compressor 2, a radiator temperature sensor 46 that detects the temperature of the radiator 4 (the temperature of the air exiting from the radiator 4 or the temperature of the radiator 4 itself: radiator temperature TCI), a radiator pressure sensor 47 that detects the refrigerant pressure in the radiator 4 (the pressure of the refrigerant inside the radiator 4 or right after exiting from the radiator 4: radiator pressure PCI), a heat sink temperature sensor 48 that detects the temperature of the heat sink 9 (the temperature of the air exiting from the heat sink 9 or the temperature of the heat sink 9 itself: heat sink temperature Te), a heat sink pressure sensor 49 that detects the refrigerant pressure of the heat sink 9 (the pressure of the refrigerant inside the heat sink 9 or right after exiting from the heat sink 9), a solar radiation sensor 51 of, for example, a photosensor type that detects the amount of solar radiation into the cabin, a vehicle speed sensor 52 that detects the moving speed of the vehicle (vehicle speed), an air conditioning operation unit 53 that sets to switch the set temperature or air conditioning operation, an outdoor heat exchanger temperature sensor 54 that detects the temperature of the outdoor heat exchanger 7 (the temperature of the refrigerant right after exiting from the outdoor heat exchanger 7 or the temperature of the outdoor heat exchanger 7 itself: outdoor heat exchanger temperature TXO, which is the evaporating temperature of the refrigerant in the outdoor heat exchanger 7 when the outdoor heat exchanger 7 functions as an evaporator), and an outdoor heat exchanger pressure sensor 56 that detects the refrigerant pressure of the outdoor heat exchanger 7 (the pressure of the refrigerant inside the outdoor heat exchanger 7 or right after exiting from the outdoor heat exchanger 7).

Moreover, to the input of the air conditioning controller 32, the output of each of the following elements is connected: a heat medium temperature sensor 76 that detects the temperature of the heat medium exiting from the heat medium flow path 64A of the refrigerant-heat medium heat exchanger 64, and a heat medium heater temperature sensor 77 that detects the temperature of the heat medium heater 66. Here, the temperature of the heat medium to be detected by the heat medium temperature sensor 76 is used as the index expressing the temperature of the battery 55 (temperature control object); therefore, in this example, the temperature of the heat medium is treated as the temperature of the battery 55 (battery temperature Tb).

On the other hand, to the output of the air conditioning controller 32, the following elements are connected: the compressor 2, the outdoor fan 15, the indoor fan (blower fan) 27, the suction switch dumper 26, the air mix dumper 28, the blowing port switch dumper 31, the outdoor expansion valve 6, the indoor expansion valve 8, the solenoid valves including the solenoid valve 22 (dehumidifying) and the solenoid valves 21 (heating), the auxiliary heater 23, the circulation pump 62, the heat medium heater 66, and the auxiliary expansion valve 73. Then, the air conditioning controller 32 controls these elements based on the output from each sensor and the setting input in the air conditioning operation unit 53.

With the above structure, the operation of the vehicle air conditioning device 1 according to the example is described. The air conditioning controller 32 (control device) performs air conditioning operation by switching the heating operation, the dehumidifying and heating operation, the internal cycle operation, the dehumidifying and cooling operation, and the cooling operation and additionally adjusts the temperature of the battery 55 (temperature control object) to be within a predetermined optimum temperature range in the example. During the operation, the air conditioning controller 32 operates the circulation pump 62 of the apparatus temperature adjustment device 61 so that the heat medium circulates in the heat medium pipe 68 as indicated by a dashed line in each drawing.

### (1) Heating Operation (External Air Heat Absorption Heating Mode)

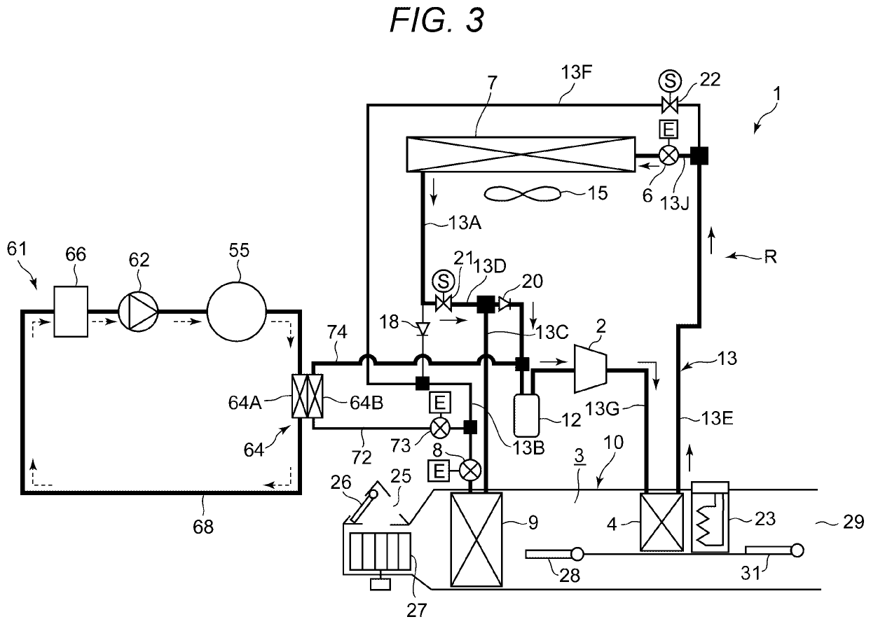

First, the heating operation is described. In this heating operation, the air conditioning controller 32 in the example can perform three modes: an external air heat absorption heating mode, a combination heating mode, and a temperature control object heat absorption heating mode. Among these modes, the external air heat absorption heating mode is usual heating operation in which heat is absorbed from the external air in the outdoor heat exchanger 7. On the other hand, in the combination heating mode and the temperature control object heat absorption heating mode, the heating is performed in a manner that the heat is absorbed from the battery 55 (temperature control object) while the temperature of the battery 55 is adjusted; therefore, these modes are described in detail below and here, first, description is made of the external air heat absorption heating mode in the heating operation with reference to FIG. 3.

FIG. 3 illustrates the flow (solid line arrow) of the refrigerant in the refrigerant circuit R in the external air heat absorption heating mode. In a case where the heating operation is selected by the air conditioning controller 32 (auto-mode) or by the manual operation in the air conditioning operation unit 53 (manual mode) and the air conditioning controller 32 performs the external air heat absorption heating mode, the air conditioning controller 32 opens the solenoid valve 21 (for heating) and fully closes the indoor expansion valve 8. In addition, the auxiliary expansion valve 73 is fully closed and the solenoid valve 22 (for dehumidifying) is also closed.

Then, the compressor 2 and the fans 15 and 27 are operated and the air mix dumper 28 adjusts the ratio of the air flowing to the radiator 4 and the auxiliary heater 23 to the air blown from the indoor fan 27. Thus, the gas refrigerant with high temperature and high pressure discharged from the compressor 2 flows in the radiator 4. Since the air in the air flow path 3 flows to the radiator 4, the air in the air flow path 3 is heated by the refrigerant with high temperature in the radiator 4, and on the other hand, the heat of the refrigerant in the radiator 4 is taken by the air and the refrigerant is cooled, and condensed to be liquid.

The refrigerant liquified in the radiator 4 flows out of the radiator 4 and then, flows to the outdoor expansion valve 6 through the refrigerant pipes 13E and 13J. The refrigerant having flowed to the outdoor expansion valve 6 is decompressed therein and then, flows into the outdoor heat exchanger 7. The refrigerant having flowed to the outdoor heat exchanger 7 evaporates and from the external air that comes in by traveling or the external air supplied from the outdoor fan 15, the heat is pumped (heat absorption). That is to say, the refrigerant circuit R serves as a heat pump. Then, the refrigerant with low temperature exiting from the outdoor heat exchanger 7 flows in the refrigerant pipe 13A, the refrigerant pipe 13D, and the solenoid valve 21 to enter the refrigerant pipe 13C, and through the check valve 20, enters the accumulator 12 where the refrigerant is separated into gas and liquid. Then, the gas refrigerant is sucked in the compressor 2. This circulation is repeated. The air heated in the radiator 4 is blown out from the blowing port 29, and thus, the cabin is heated.

The air conditioning controller 32 calculates a target radiator pressure PCO (target value of pressure PCI of radiator 4) from target heater temperature TCO (target value of air temperature on the lee side of the radiator 4) that is calculated based on target blowing temperature TAO, which is described below, controls the revolution speed of the compressor 2 based on the target radiator pressure PCO and the refrigerant pressure of the radiator 4 that is detected by the radiator pressure sensor 47 (radiator pressure PCI, high pressure of refrigerant circuit R), controls the valve opening degree of the outdoor expansion valve 6 based on the temperature of the radiator 4 that is detected by the radiator temperature sensor 46 (radiator temperature TCI) and the radiator pressure PCI detected by the radiator pressure sensor 47, and controls the supercooling degree of the refrigerant at the outlet of the radiator 4. The target heater temperature TCO is basically equal to TAO; however, a predetermined restriction is provided in point of control. If the heating capability by the radiator 4 is insufficient, electricity is supplied to the auxiliary heater 23 so that heat is generated and thus, the heating capability is assisted (compensated).

### (2) Dehumidifying and Heating Operation

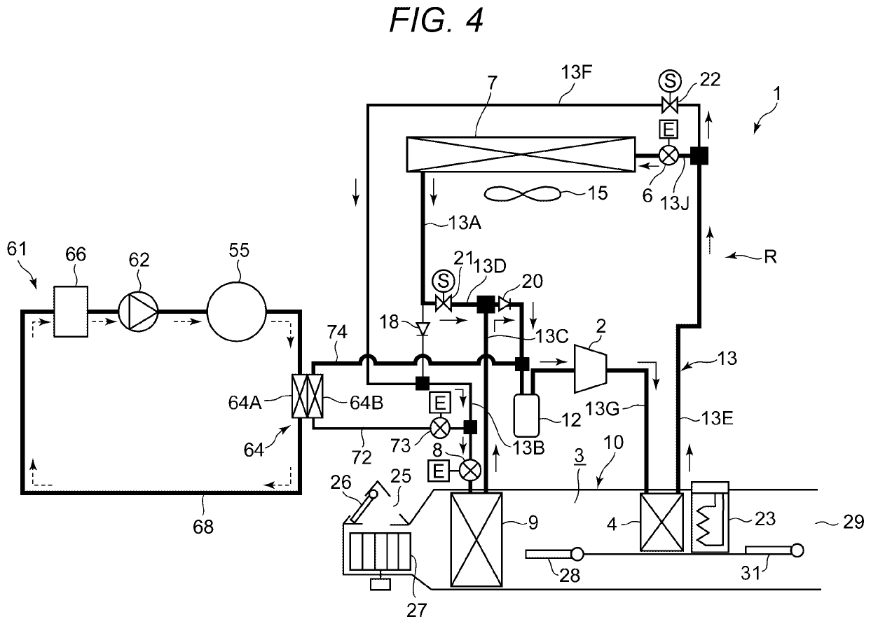

Next, the dehumidifying and heating operation as one kind of the dehumidifying operation is described with reference to FIG. 4. FIG. 4 illustrates the flow (solid line arrow) of the refrigerant in the refrigerant circuit R in the dehumidifying and heating operation. In the dehumidifying and heating operation, the air conditioning controller 32 opens the solenoid valve 22 and the indoor expansion valve 8 in the external air heat absorption heating mode in the heating operation so that the refrigerant is decompressed and expanded. Thus, part of the condensed refrigerant flowing in the refrigerant pipe 13E through the radiator 4 is branched and the branched refrigerant flows into the refrigerant pipe 13F through the solenoid valve 22, and flows from the refrigerant pipe 13B to the indoor expansion valve 8 and the rest of the refrigerant flows to the outdoor expansion valve 6. That is to say, part of the refrigerant that is branched is decompressed at the indoor expansion valve 8 and flows to the heat sink 9, where the refrigerant evaporates.

The air conditioning controller 32 controls the valve opening degree of the indoor expansion valve 8 so as to maintain the superheating degree (SH) of the refrigerant at the outlet of the heat sink 9 to a predetermined value, and in this case, the moisture in the air blown from the indoor fan 27 is condensed and adheres in the heat sink 9 by the heat absorption operation of the refrigerant generated in the heat sink 9; thus, the air is cooled and dehumidified. The rest of the refrigerant having flowed to the refrigerant pipe 13J after the branch is decompressed at the outdoor expansion valve 6 and then, evaporates in the outdoor heat exchanger 7.

The refrigerant evaporating in the heat sink 9 goes to the refrigerant pipe 13C and merges with the refrigerant from the refrigerant pipe 13D (the refrigerant from the outdoor heat exchanger 7), and then, flows through the check valve 20 and the accumulator 12 and then is sucked into the compressor 2; this circulation is repeated. The air dehumidified in the heat sink 9 is heated again in the process of passing the radiator 4; thus, the cabin is dehumidified and heated.

The air conditioning controller 32 controls the revolution speed of the compressor 2 based on the target radiator pressure PCO calculated from the target heater temperature TCO and the radiator pressure PCI detected by the radiator pressure sensor 47 (high pressure in refrigerant circuit R), and controls the valve opening degree of the outdoor expansion valve 6 based on the temperature of the heat sink 9 detected by the heat sink temperature sensor 48 (heat sink temperature Te).

### (3) Internal Cycle Operation

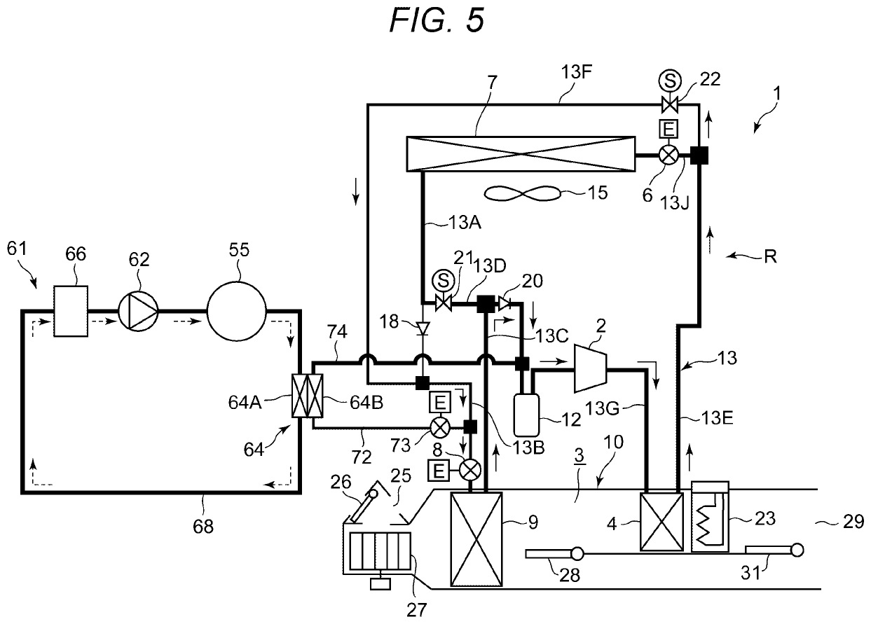

Next, the internal cycle operation as one kind of the dehumidifying operation is described with reference to FIG. 5. FIG. 5 illustrates the flow (solid line arrow) of the refrigerant in the refrigerant circuit R in the internal cycle operation. In the internal cycle operation, the air conditioning controller 32 fully closes the outdoor expansion valve 6 in the aforementioned dehumidifying and heating operation (fully closed position). However, the solenoid valve 21 keeps open and the refrigerant outlet of the outdoor heat exchanger 7 remains communicating with the refrigerant sucking side of the compressor 2. That is to say, this internal cycle operation is performed while the outdoor expansion valve 6 is fully closed by the control of the outdoor expansion valve 6 in the dehumidifying and heating operation; thus, this internal cycle operation can also be regarded as part of the dehumidifying and heating operation.

However, closing the outdoor expansion valve 6 interrupts the flow of the refrigerant into the outdoor heat exchanger 7; therefore, the condensed refrigerant flowing in the refrigerant pipe 13E through the radiator 4 entirely flows to the refrigerant pipe 13F through the solenoid valve 22. Then, the refrigerant flowing in the refrigerant pipe 13F flows to the indoor expansion valve 8 through the refrigerant pipe 13B. After the refrigerant is decompressed at the indoor expansion valve 8, the refrigerant flows in the heat sink 9 and evaporates. The moisture in the air blown from the indoor fan 27 by the heat absorption operation at this time is condensed and adheres in the heat sink 9; therefore, the air is cooled and dehumidified.

The refrigerant evaporating in the heat sink 9 flows in the refrigerant pipe 13C, and is sucked in the compressor 2 through the check valve 20 and the accumulator 12, and this circulation is repeated. The air dehumidified in the heat sink 9 is heated again in the process of passing the radiator 4; thus, the cabin is dehumidified and heated. In this internal cycle operation, the refrigerant circulates between the radiator 4 (radiation) and the heat sink 9 (heat absorption) in the air flow path 3 inside the cabin, and therefore, the heat is not pumped from the external air and the heating capability for the consumed motive power of the compressor 2 is obtained. Since the entire refrigerant flows to the heat sink 9 that has the dehumidifying operation, the dehumidifying capability is higher but the heating capability is lower than that in the dehumidifying and heating operation.

Although the outdoor expansion valve 6 is closed, the solenoid valve 21 is open and the refrigerant outlet of the of the outdoor heat exchanger 7 communicates with the refrigerant suction side of the compressor 2; thus, the liquid refrigerant in the outdoor heat exchanger 7 flows out to the refrigerant pipe 13C through the refrigerant pipe 13A, the refrigerant pipe 13D, and the solenoid valve 21 and is collected in the accumulator 12, and the refrigerant exists as gas in the outdoor heat exchanger 7. Thus, as compared to when the solenoid valve 21 is closed, the amount of refrigerant circulating in the refrigerant circuit R increases and the heating capability of the radiator 4 and the dehumidifying capability of the heat sink 9 can be improved.

The air conditioning controller 32 controls the revolution speed of the compressor 2 based on the temperature of the heat sink 9 (heat sink temperature Te) or the aforementioned radiator pressure PCI (high pressure in refrigerant circuit R). Here, the air conditioning controller 32 controls the compressor 2 by selecting the lower target revolution speed of the compressor obtained by any of the calculations based on the heat sink temperature Te and the radiator pressure PCI.

### (4) Dehumidifying and Cooling Operation

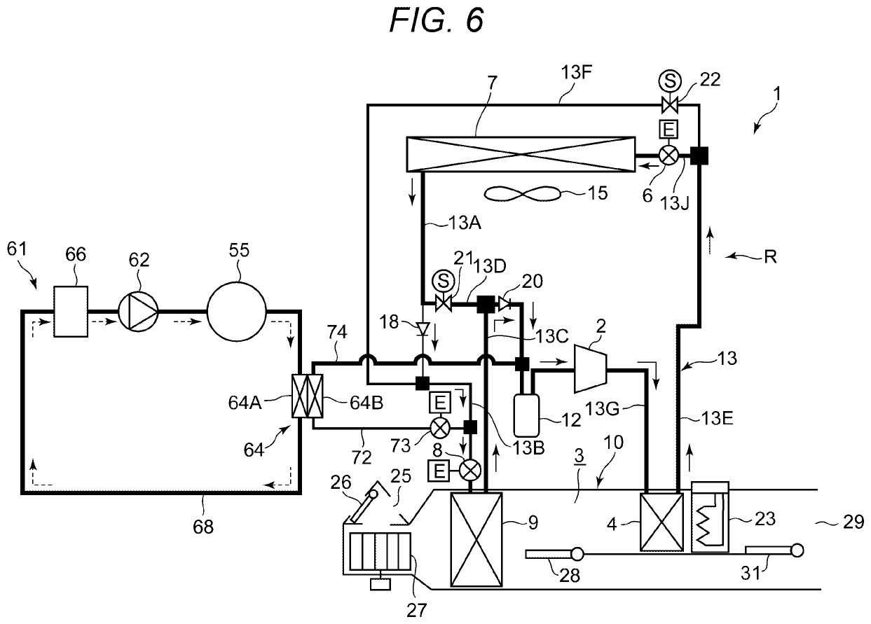

Next, the dehumidifying and cooling operation as one kind of the dehumidifying operation is described with reference to FIG. 6. FIG. 6 illustrates the flow (solid line arrow) of the refrigerant in the refrigerant circuit R in the dehumidifying and cooling operation. In the dehumidifying and cooling operation, the air conditioning controller 32 opens the indoor expansion valve 8 and decompresses and expands the refrigerant, and closes the solenoid valve 21 and the solenoid valve 22. In addition, the auxiliary expansion valve 73 is fully closed. Then, the compressor 2, and the fans 15 and 27 are operated to produce the state in which the ratio of the air that is supplied to the radiator 4 and the auxiliary heater 23 to the air blown from the indoor fan 27 is adjusted by the air mix dumper 28. Thus, the gas refrigerant with high temperature and high pressure discharged from the compressor 2 flows into the radiator 4. To the radiator 4, the air in the air flow path 3 is supplied, and thus the air in the air flow path 3 is heated by the refrigerant with high temperature in the radiator 4 and on the other hand, the heat of the refrigerant in the radiator 4 is taken by the air, so that the refrigerant is cooled and condensed to be liquid.

The refrigerant exiting from the radiator 4 flows to the outdoor expansion valve 6 through the refrigerant pipe 13E, and through the outdoor expansion valve 6 that is controlled to be a little open (valve opening degree larger than that in heating operation or the like), enters the outdoor heat exchanger 7. The refrigerant having entered the outdoor heat exchanger 7 is air-cooled by the external air that comes in by traveling or by the external air supplied by the outdoor fan 15, so that the refrigerant is condensed. The refrigerant exiting from the outdoor heat exchanger 7 enters the refrigerant pipe 13B through the refrigerant pipe 13A and the check valve 18, and then enters the indoor expansion valve 8. After the refrigerant is decompressed at the indoor expansion valve 8, the refrigerant flows in the heat sink 9 and evaporates. Due to the heat absorption operation here, the moisture in the air blown from the indoor fan 27 is condensed and adheres in the heat sink 9; thus, the air is cooled and dehumidified.

The refrigerant evaporating in the heat sink 9 goes to the accumulator 12 through the refrigerant pipe 13C and the check valve 20, and then is sucked in the compressor 2; this circulation is repeated. The air cooled and dehumidified in the heat sink 9 is reheated (reheat: radiating capability is lower than at heating) in the process of passing the radiator 4; therefore, the cabin is dehumidified and cooled.

On the basis of the temperature of the heat sink 9 (heat sink temperature Te) detected by the heat sink temperature sensor 48 and the target value thereof, the target heat sink temperature TEO, the air conditioning controller 32 controls the revolution speed of the compressor 2 so that the heat sink temperature Te becomes the target heat sink temperature TEO. Moreover, based on the radiator pressure PCI (high pressure in refrigerant circuit R) detected by the radiator pressure sensor 47 and the target radiator pressure PCO calculated from the target heater temperature TCO (target value of radiator pressure PCI), the air conditioning controller 32 controls the valve opening degree of the outdoor expansion valve 6 so that the radiator pressure PCI becomes the target radiator pressure PCO. Thus, the necessary reheating quantity by the radiator 4 is obtained.

### (5) Cooling Operation

Next, the cooling operation is described. The flow in the refrigerant circuit R is similar to that in the dehumidifying and cooling operation in FIG. 6. In the cooling operation, the air conditioning controller 32 maximizes the valve opening degree of the outdoor expansion valve 6 in the aforementioned dehumidifying and cooling operation. Note that the air mix dumper 28 is in the state of adjusting the ratio of supplying the air to the radiator 4 and the auxiliary heater 23.

Thus, the gas refrigerant with high temperature and high pressure discharged from the compressor 2 flows in the radiator 4. Although the air in the air flow path 3 flows in the radiator 4, the ratio is small (because it is only reheating in the cooling) and therefore, here, the air just passes and the refrigerant exiting from the radiator 4 flows to the outdoor expansion valve 6 through the refrigerant pipe 13E. Since the outdoor expansion valve 6 is fully open here, the refrigerant continuously passes the refrigerant pipe 13J through the outdoor expansion valve 6, flows in the outdoor heat exchanger 7, and by the external air that comes in by traveling or by the external air supplied by the outdoor fan 15, the refrigerant is air-cooled and condensed to be liquid. The refrigerant exiting from the outdoor heat exchanger 7 enters the refrigerant pipe 13B through the refrigerant pipe 13A and the check valve 18, and then enters the indoor expansion valve 8. After the refrigerant is decompressed at the indoor expansion valve 8, the refrigerant flows in the heat sink 9 and evaporates. By the heat absorption operation here, the moisture in the air blown from the indoor fan 27 is condensed and adheres in the heat sink 9, and thus the air is cooled.

The refrigerant evaporating in the heat sink 9 reaches the accumulator 12 through the refrigerant pipe 13C and the check valve 20, and then is sucked in the compressor 2; this circulation is repeated. The air cooled and dehumidified in the heat sink 9 is blown into the cabin from the blowing port 29; thus, the cabin is cooled. In this cooling operation, the air conditioning controller 32 controls the revolution speed of the compressor 2 based on the temperature of the heat sink 9 (heat sink temperature Te) detected by the heat sink temperature sensor 48.

### (6) Switching of Air Conditioning Operation

The air conditioning controller 32 calculates the target blowing temperature TAO described above from the following Expression (I). This target blowing temperature TAO is the target value of the temperature of the air blown from the blowing port 29 into the cabin.

TAO=(Tset−Tin)×K+Tbal(f(Tset, SUN, Tam)) (I)

Here, Tset represents the set temperature in the cabin, which is set by the air conditioning operation unit 53, Tin represents the temperature of the air in the cabin detected by the inside temperature sensor 37, K represents a constant, and Tbal represents a balance value calculated from the set temperature Tset, the amount of solar radiation SUN detected by the solar radiation sensor 51, and the outside temperature Tam detected by the outside temperature sensor 33. Generally, the target blowing temperature TAO is higher as the outside temperature Tam is lower, and is lower as the outside temperature Tam is higher.

Then, at the start, the air conditioning controller 32 selects any of the aforementioned kinds of air conditioning operation based on the outside temperature Tam detected by the outside temperature sensor 33 and the target blowing temperature TAO. After the start, the air conditioning controller 32 selects and switches the air conditioning operation in accordance with the change of the operation condition or the setting or the environment, for example the outside temperature Tam, the target blowing temperature TAO, or the battery temperature Tb.

### (7) Temperature Adjustment of Battery 55 (Temperature Control Object) in Heating Operation

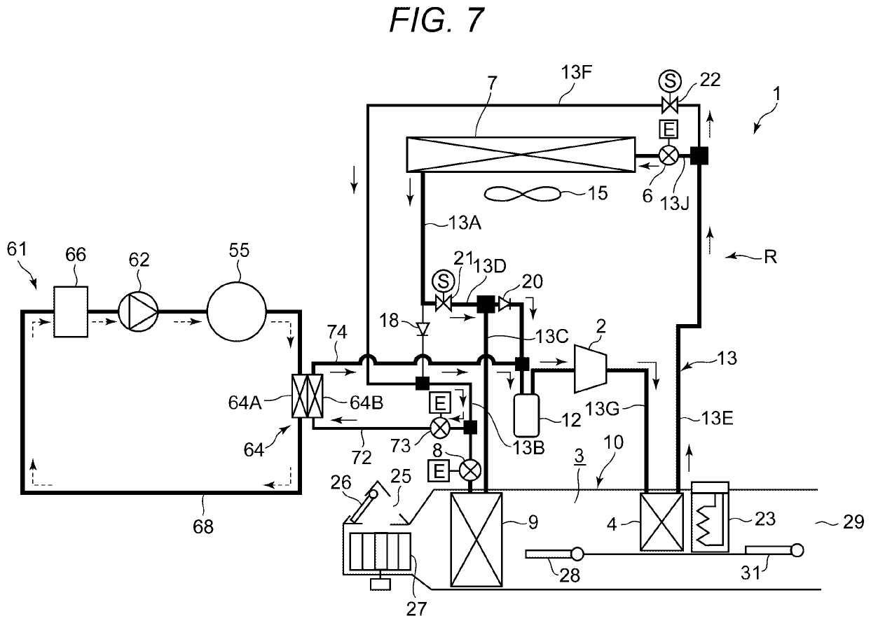

Next, the temperature adjustment control of the battery 55 (temperature control object) by the air conditioning controller 32 is described with reference to FIG. 7 to FIG. 9. As described above, charging and discharging the battery 55 with the temperature increased due to heat generation from itself or the like results in further deterioration. In view of this, the air conditioning controller 32 of the vehicle air conditioning device 1 according to the example causes the apparatus temperature adjustment device 61 to cool the battery 55 (temperature control object) to be within the optimum temperature range while performing the air conditioning operation as described above. The optimum temperature range of the battery 55 is generally +25° C. or more and +45° C. or less. Therefore, in this example, a target battery temperature TBO (for example, +35° C.) corresponding to the target value of the temperature (battery temperature Tb) of the battery 55 is set in this optimum temperature range.

First, in the heating operation of the air conditioning controller 32, for example, a request heating capability Qtgt corresponding to the capability of heating the cabin, which is requested for the radiator 4, and a heating capability Qhp that can be generated by the radiator 4 are calculated using the following Expressions (II) and (III):

Qtgt=(TCO−Te)×Cpa×p×Qair (II)

Qhp=f(Tam, NC, BLV, VSP, FANVout, Te) (III)

Here, Te represents the temperature of the heat sink 9 detected by the heat sink temperature sensor 48, Cpa represents the specific heat of the air that enters the radiator 4 [kj/kg·K], p represents the density (specific volume) of the air that enters the radiator 4 [kg/m³], Qair represents the quantity of air passing the radiator 4 [m³/h] (estimated from blower voltage BLV of the indoor fan 27, for example), VSP represents the vehicle speed obtained from the vehicle speed sensor 52, and FANVout represents the voltage of the outdoor fan 15.

On the basis of the battery temperature Tb (the temperature of the heat medium that is the index of the temperature of the battery 55) detected by the heat medium temperature sensor 76 and the aforementioned target battery temperature TBO, the air conditioning controller 32 calculates a request temperature control object cooling capability Qbat corresponding to the capability of cooling the battery 55 (temperature control object) that is requested for the refrigerant-heat medium heat exchanger 64 (temperature control object heat exchanger) of the apparatus temperature adjustment device 61 using the following Expression (IV):

Qbat=(Tb−TBO)×k×k2 (IV)

Here, k1 represents the specific heat [kj/kg·K] of the heat medium circulating in the apparatus temperature adjustment device 61, and k2 represents the flow rate of the heat medium [m³/h]. Note that the expression for calculating the request temperature control object cooling capability Qbat is not limited to the aforementioned one, and the request temperature control object cooling capability Qbat may be calculated in consideration of other factors related to the batter cooling.

If the battery temperature Tb is lower than the target battery temperature TBO (Tb<TBO), the request temperature control object cooling capability Qbat calculated by the above expression (IV) is negative; therefore, in the example, the air conditioning controller 32 fully closes the auxiliary expansion valve 73 and performs the external air heat absorption heating mode in the aforementioned heating operation (FIG. 3).

On the other hand, if the battery temperature Tb increases to become higher than the target battery temperature TBO (TBO<Tb) due to the charging/discharging or the like, that is, if the battery 55 needs to be cooled, the request temperature control object cooling capability Qbat calculated by Expression (IV) becomes positive; therefore, in the example, the air conditioning controller 32 opens the auxiliary expansion valve 73 and the apparatus temperature adjustment device 61 starts to cool the battery 55.

That is to say, the air conditioning controller 32 in the example performs the aforementioned external air heat absorption heating mode when the request temperature control object cooling capability Qbat is negative. On the other hand, when the request temperature control object cooling capability Qbat is positive, the air conditioning controller 32 shifts to the state of performing the combination heating mode and the temperature control object heat absorption heating mode, which are described below, and by comparing the request heating capability Qtgt and the request temperature control object cooling capability Qbat, switches between the combination heating mode and the temperature control object heat absorption heating mode.

Therefore, based on the request temperature control object cooling capability Qbat obtained from the battery temperature Tb, the air conditioning controller 32 performs the heating operation while switching the external air heat absorption heating mode, the combination heating mode, and the temperature control object heat absorption heating mode.

### (7-1) Combination Heating Mode

In the case where the request heating capability Qtgt is more than the request temperature control object cooling capability Qbat (Qtgt>Qbat) in a situation where the heating load in the cabin is large (for example, the temperature of the internal air is low) and the heat generation of the battery 55 is relatively small (cooling load is small), the air conditioning controller 32 performs the combination heating mode. FIG. 7 illustrates the flow (solid line arrow) of the refrigerant in the refrigerant circuit R in this combination heating mode.

In this combination heating mode, the air conditioning controller 32 opens the solenoid valve 22 and the auxiliary expansion valve 73 and controls the valve opening degree thereof in the external air heat absorption heating mode in the heating operation of the refrigerant circuit R illustrated in FIG. 3. Thus, part of the refrigerant exiting from the radiator 4 is branched on the refrigerant upstream side of the outdoor expansion valve 6, and flows in the refrigerant pipe 13B through the refrigerant pipe 13F. The refrigerant then enters the branch pipe 72 and is decompressed at the auxiliary expansion valve 73, and through the branch pipe 72, flows in the refrigerant flow path 64B of the refrigerant-heat medium heat exchanger 64, where the refrigerant evaporates. Here, the heat absorption operation is exhibited. The refrigerant evaporating in the refrigerant flow path 64B enters the refrigerant pipe 13C on the downstream side of the check valve 20 through the refrigerant pipe 74, and through the accumulator 12, is sucked in the compressor 2; this circulation is repeated.

On the other hand, the heat medium discharged from the circulation pump 62 to the heat medium pipe 68 flows to the battery 55, where the heat medium exchanges heat with the battery 55. After that, the heat medium flows to the heat medium flow path 64A of the refrigerant-heat medium heat exchanger 64, where the heat of the heat medium is absorbed by the refrigerant evaporating in the refrigerant flow path 64B and accordingly, the heat medium is cooled. The heat medium cooled by the heat absorption operation of the refrigerant exits from the refrigerant-heat medium heat exchanger 64 and flows to the heat medium heater 66, where the heat medium exchanges heat with the heat medium heater 66. Then, the heat medium is sucked in the circulation pump 62. This circulation is repeated (as indicated by a dashed line arrow in FIG. 7).

In this manner, in the combination heating mode, the outdoor heat exchanger 7 and the refrigerant-heat medium heat exchanger 64 are connected in parallel with respect to the flow of the refrigerant in the refrigerant circuit R, and the refrigerant flows to the outdoor heat exchanger 7 and the refrigerant-heat medium heat exchanger 64 and evaporates in the respective heat exchangers. Then, the refrigerant absorbs heat from the external air and also absorbs heat from the heat medium (battery 55) of the apparatus temperature adjustment device 61. Accordingly, the heat is pumped from the battery 55 (temperature control object) through the heat medium so that the battery 55 is cooled, and the pumped heat is sent to the radiator 4; thus, the heat is used to heat the cabin.

In this combination heating mode, in the case where the request heating capability Qtgt cannot be achieved by the heating capability Qhp of the radiator 4 even by the heat absorption from the external air and the heat absorption from the battery 55 (temperature control object) as described above (Qtgt>Qhp), the air conditioning controller 32 causes the heat medium heater 66 to generate heat (energization).

When the heat medium heater 66 generates heat, the heat medium sucked in the circulation pump 62 of the apparatus temperature adjustment device 61 is heated by the heat medium heater 66 and then, sequentially flows from the circulation pump 62 to the battery 55 and the heat medium flow path 64A of the refrigerant-heat medium heat exchanger 64. Thus, the heat from the heat medium heater 66 is also pumped by the refrigerant evaporating in the refrigerant flow path 64B and the heating capability Qhp by the radiator 4 increases and the request heating capability Qtgt can be achieved. Note that the air conditioning controller 32 stops the heat generation of the heat medium heater 66 (stops energization) when the heating capability Qhp has attained the request heating capability Qtgt.

### (7-2) Temperature Control Object Heat Absorption Heating Mode

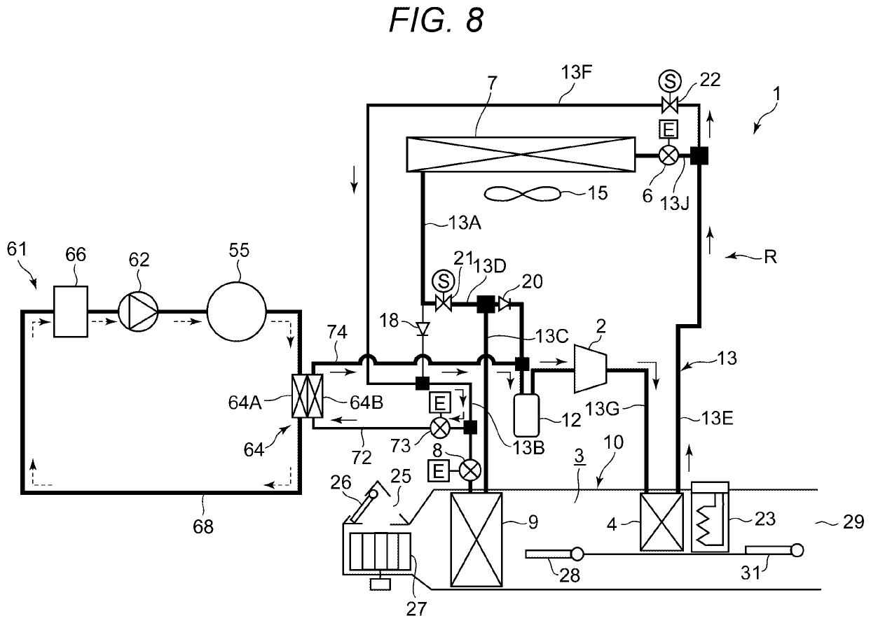

Next, when the heating load in the cabin and the cooling load of the battery 55 are substantially the same and the cabin can be heated with the heat of the battery 55, that is, when the request heating capability Qtgt and the request temperature control object cooling capability Qbat are equal or similar (Qtgt≈Qbat), the cabin can be heated with the heat of the battery 55. When the heating load in the cabin is small (for example, the temperature of the internal air is relatively high) and the heat generation of the battery 55 is large (cooling load is large), that is, when the request battery cooling capability Qbat is more than the request heating capability Qtgt (Qtgt<Qbat), the cabin can also be heated with the heat of the battery 55. In this case, the air conditioning controller 32 performs the temperature control object heat absorption heating mode. FIG. 8 illustrates the flow (solid line arrow) of the refrigerant in the refrigerant circuit R in the temperature control object heat absorption heating mode.

In this temperature control object heating mode, the air conditioning controller 32 closes the solenoid valve 21 (this may be open because the check valve 20 is present), fully closes the outdoor expansion valve 6 and the indoor expansion valve 8, opens the solenoid valve 22, and also opens the auxiliary expansion valve 73, and controls the valve opening degrees thereof. Then, the compressor 2 and the indoor fan 27 are operated (heat medium heater 66 is not energized). Thus, the entire refrigerant exiting from the radiator 4 flows to the solenoid valve 22, and enters the refrigerant pipe 13B through the refrigerant pipe 13F. Then, the refrigerant enters the branch pipe 72, is decompressed at the auxiliary expansion valve 73, and then flows in the refrigerant flow path 64B of the refrigerant-heat medium heat exchanger 64 through the branch pipe 72, where the refrigerant evaporates. Here, the heat absorption operation is exhibited. The refrigerant having evaporated in this refrigerant flow path 64B enters the refrigerant pipe 13C on the downstream side of the check valve 20 through the refrigerant pipe 74, and is sucked in the compressor 2 through the accumulator 12; this circulation is repeated.

On the other hand, the heat medium discharged from the circulation pump 62 to the heat medium pipe 68 flows to the battery 55, where the heat medium exchanges heat with the battery 55 and flows to the heat medium flow path 64A of the refrigerant-heat medium heat exchanger 64, where the heat of the heat medium is absorbed by the refrigerant evaporating in the refrigerant flow path 64B and the heat medium is cooled accordingly. The heat medium cooled by the heat absorption operation of the refrigerant exits from the refrigerant-heat medium heat exchanger 64 and flows to the heat medium heater 66, and then is sucked in the circulation pump 62; this circulation is repeated (indicated by a dashed line arrow in FIG. 8).

In this manner, in the temperature control object heat absorption heating mode, the refrigerant in the refrigerant circuit R evaporates in the refrigerant-heat medium heat exchanger 64 and absorbs heat only from the heat medium (battery 55) of the apparatus temperature adjustment device 61. That is to say, the refrigerant neither flows in the outdoor heat exchanger 7 nor evaporates therein, and the refrigerant pumps heat only from the battery 55 through the heat medium. Accordingly, while the problem of the frosting of the outdoor heat exchanger 7 is solved, the battery 55 can be cooled and the heat pumped from the battery 55 (temperature control object) can be conveyed to the radiator 4 and the cabin can be heated.

### (7-3) Control at Start in Heating Operation

Here, in the temperature control object heat absorption heating mode in FIG. 8, the outdoor expansion valve 6 is closed; therefore, the refrigerant does not flow to the outdoor heat exchanger 7 and the refrigerant flows only in the refrigerant-heat medium heat exchanger 64 of the apparatus temperature adjustment device 61. In addition, in the temperature control object heat absorption heating mode, the sucking pressure of the compressor 2 becomes higher than the saturation pressure of the external air due to the influence of the temperature of the heat medium (battery temperature Tb).

In a case where the refrigerant remains in a region from the outdoor expansion valve 6 to the check valve 20 (region of outdoor expansion valve 6-refrigerant pipe 13J-outdoor heat exchanger 7-refrigerant pipe 13A-refrigerant pipe 13D-solenoid valve 21-refrigerant pipe 13C-check valve 20) in such a circumstance, the pressure in this region is lower than the sucking pressure of the compressor 2 in the temperature control object heat absorption heating mode. Therefore, the remaining refrigerant cannot be collected in the refrigerant circulation region in the refrigerant circuit R including the compressor 2 and the circulation refrigerant quantity in the temperature control object heat absorption heating mode decreases and the sufficient heating performance cannot be exhibited.

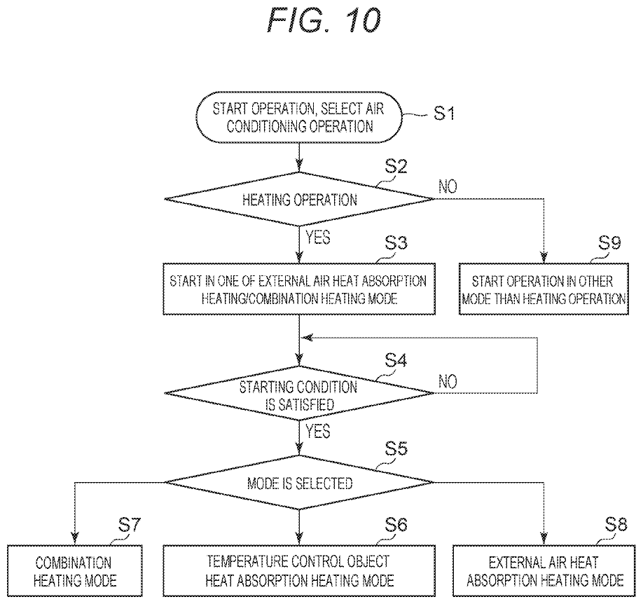

In view of this, the air conditioning controller 32 selects the heating operation at the start, and when the compressor 2 is started in the heating operation, any of the external air heat absorption heating mode (FIG. 3) and the combination heating mode (FIG. 7), which are described above, is used. The control at the start in the heating operation by the air conditioning controller 32 is described below with reference to the flowchart in FIG. 10.

The air conditioning controller 32 starts to operate (becomes active) in step S1 in FIG. 10, and selects any one of the aforementioned air conditioning operation. Next, whether the heating operation is selected is determined in step S2, and if the air conditioning operation other than the heating operation is selected, the process advances to step S9 and the selected air conditioning operation is started.

On the other hand, if the heating operation is selected in step S2, the air conditioning controller 32 advances the process to step S3 and starts the compressor 2 in any of the external air heat absorption heating mode (FIG. 3) and the combination heating mode (FIG. 7) that are described above. By starting in the external air heat absorption heating mode or the combination heating mode in this manner, the refrigerant always flows to the outdoor heat exchanger 7 at the start. Thus, the sucking pressure of the compressor 2 becomes lower than the saturation pressure of the external air; therefore, the refrigerant remaining in the outdoor heat exchanger 7 or the like is collected in the compressor 2.

After the heating operation is started in this manner, the air conditioning controller 32 determines whether a predetermined starting condition is satisfied in step S4. The starting condition in the example is as follows.
(a) A predetermined time has elapsed since the heating operation started.
(b) The refrigerant sucking pressure of the compressor 2 has decreased to be lower than or equal to a predetermined value and this state has continued for a predetermined time.
(c) The refrigerant sucking temperature of the compressor 2 has decreased to be lower than or equal to a predetermined value and this state has continued for a predetermined time.

Note that the refrigerant sucking temperature is the temperature detected by the sucking temperature sensor 44 and the refrigerant sucking pressure is the pressure calculated based on the refrigerant sucking temperature. The starting condition may be any one of the above (a) to (c) conditions, a combination of these conditions, or the entire conditions.

In a case where the starting condition as above is satisfied, it can be determined that the refrigerant remaining in the outdoor heat exchanger 7 or the like has been collected in the compressor 2. The air conditioning controller 32 waits until the starting condition is satisfied in step S4 and if the condition is satisfied, the process advances to step S5 and any one of the external air heat absorption heating mode, the combination heating mode, and the temperature control object heat absorption heating mode is selected and performed based on the request temperature control object cooling capability Qbat as described above.

That is to say, in this example, if the request temperature control object cooling capability Qbat is negative in step S5, the process advances to step S8 and the external air heat absorption heating mode is performed, and if the request temperature control object cooling capability Qbat is positive and Qtgt>Qbat is satisfied in step S5, the process advances to step S7 and the combination heating mode is performed. Moreover, if the request temperature control object cooling capability Qbat is positive and Qtgt≈Qbat or Qtgt<Qbat, the process advances to step S6 and the temperature control object heat absorption heating mode is performed.

Here, in the example, the three modes of the external air heat absorption heating mode, the combination heating mode, and the temperature control object heat absorption heating mode are performed in the heating operation; however, in the case of the vehicle air conditioning device that can perform only the external air heat absorption heating mode and the temperature control object heat absorption heating mode, the heating operation is started in the external air heat absorption heating mode in step S3 in FIG. 10. Furthermore, in the case of the vehicle air conditioning device that can perform only the combination heating mode and the temperature control object heat absorption heating mode, the heating operation is started in the combination heating mode in step S3 in FIG. 10.

### (7-4) Other Examples of Mode Selection

In the mode selection in step S5, after the request temperature control object cooling capability Qbat becomes positive, which to choose from between the temperature control object heat absorption heating mode and the combination heating mode is not limited to the aforementioned example and for example, the temperature control object heat absorption heating mode may be selected when any of the following conditions (d) to (g) is satisfied and the combination heating mode may be selected in the other cases.
(d) The request temperature control object cooling capability Qbat is more than or equal to a predetermined value Qbat1 and the outside temperature Tam is less than or equal to a predetermined value Tam1.
(e) In addition to the condition (d), the battery temperature Tb (temperature of heat medium) is more than or equal to a predetermined value Tb1.
(f) The outside temperature Tam is less than or equal to the predetermined value Tam1.
(g) The outdoor heat exchanger temperature TXO is more than or equal to a predetermined value TXO1.

The reason is that it is considered the cabin can be heated with the heat of the battery 55 when the request temperature control object cooling capability Qbat is high or the battery temperature Tb is high, and when the outside temperature Tam is low or the outdoor heat exchanger temperature TXO is high, it is difficult to absorb heat from the external air and on the contrary, the frosting of the outdoor heat exchanger 7 is concerned.

### (8) Temperature Adjustment of Battery 55 (Temperature Control Object) in the Other Air Conditioning Operation

Here, in the case where the battery temperature Tb increases to be higher than the target battery temperature TBO (TBO<Tb) due to the charging/discharging or the like in the air conditioning operation other than the heating operation, the air conditioning controller 32 opens the auxiliary expansion valve 73 and causes the apparatus temperature adjustment device 61 to cool the battery 55. For example, the cooling/temperature control object temperature adjustment mode for cooling the battery 55 in the cooling operation is exhibited.

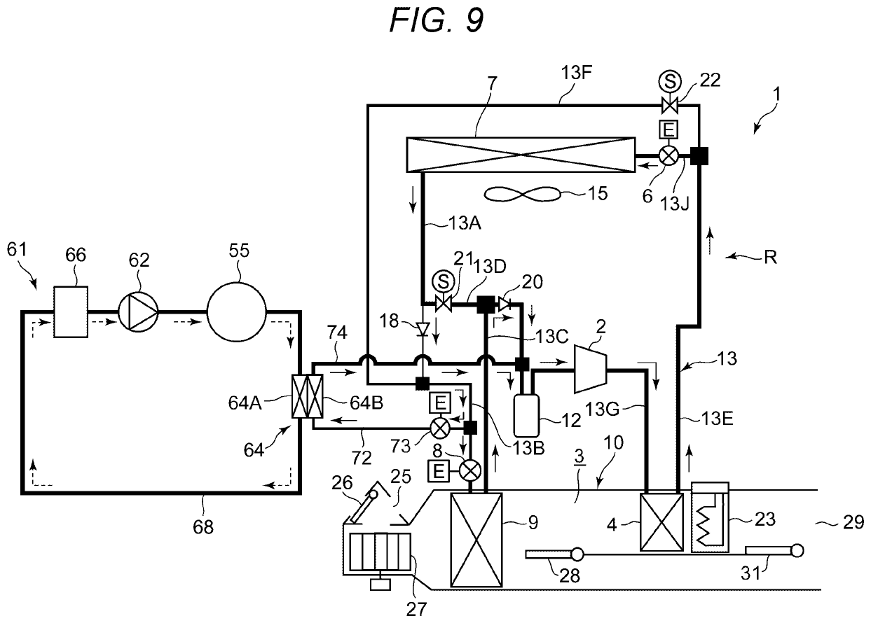

In this cooling/temperature control object temperature adjustment mode, the air conditioning controller 32 opens the auxiliary expansion valve 73 and controls the valve opening degree thereof in the state of the refrigerant circuit R performing the cooling operation in FIG. 6 described above (the same as dehumidifying and cooling operation), and performs heat exchange between the heat medium and the refrigerant in the refrigerant-heat medium heat exchanger 64. Note that the heat medium heater 66 is not energized. FIG. 9 illustrates the flow (solid line arrow) of the refrigerant in the refrigerant circuit R in the cooling/temperature control object temperature adjustment mode.

Thus, the refrigerant with high temperature discharged from the compressor 2 flows in the outdoor heat exchanger 7 sequentially through the radiator 4 and the outdoor expansion valve 6, and the external air that flows in by the travel exchanges heat with the external air that is supplied by the outdoor fan 15 and radiates heat, and then is condensed. Part of the refrigerant condensed in the outdoor heat exchanger 7 flows from the refrigerant pipe 13B to the indoor expansion valve 8, where the refrigerant is decompressed and flows in the heat sink 9 and then evaporates therein. Due to the heat absorption operation at this time, the air in the air flow path 3 is cooled and thus, the cabin is cooled.

The rest of the refrigerant having been condensed in the outdoor heat exchanger 7 and flowed into the refrigerant pipe 13B is branched into the branch pipe 72 and decompressed at the auxiliary expansion valve 73, and then, the refrigerant evaporates in the refrigerant flow path 64B of the refrigerant-heat medium heat exchanger 64. The refrigerant absorbs heat from the heat medium circulating in the apparatus temperature adjustment device 61, so that the battery 55 is cooled in a manner similar to the above-described process. Note that the refrigerant exiting from the heat sink 9 is sucked in the compressor 2 through the refrigerant pipe 13C, the check valve 20, and the accumulator 12, and the refrigerant exiting from the refrigerant-heat medium heat exchanger 64 also flows through the refrigerant pipe 74, the refrigerant pipe 13C, and the accumulator 12, and is sucked in the compressor 2.

As specifically described above, in the heating operation, the external air heat absorption heating mode for heating the cabin in a manner that the refrigerant absorbs heat in the outdoor heat exchanger 7, the temperature control object heat absorption heating mode for heating the cabin in a manner that the refrigerant absorbs heat in the refrigerant-heat medium heat exchanger 64, and the combination heating mode for heating the cabin in a manner that the refrigerant absorbs heat in the outdoor heat exchanger 7 and the refrigerant-heat medium heat exchanger 64 are provided, and these modes are performed while being switched. In the case where the cabin is heated by the heat pumped from the external air in the external air heat absorption heating mode and for example, the battery 55 needs to be cooled and the cabin can be heated with the heat from the battery 55, generally, heat is pumped from the battery 55 as the temperature control object heat absorption heating mode, and while the battery 55 is cooled, the cabin can be heated. In another example, when the heat generation from the battery 55 is relatively small, heat is pumped from the external air and the battery 55 by the combination heating mode, and while the battery 55 is cooled, the cabin can be heated without any trouble. Thus, the cabin can be heated efficiently by effectively using the heat of the battery 55, and while the frosting of the outdoor heat exchanger 7 is suppressed, the battery 55 can be cooled as appropriate.

In particular, the air conditioning controller 32 starts the heating operation in the external air heat absorption heating mode or the combination heating mode; therefore, even when the refrigerant remains in the outdoor heat exchanger 7 or the like, this remaining refrigerant can be collected by performing the external air heat absorption heating mode or the combination heating mode at the start. Thus, the inconvenience that the refrigerant remains in the outdoor heat exchanger 7 or the like and the circulation refrigerant quantity in performing the temperature control object heat absorption heating mode decreases so that the heating capability deteriorates can be solved and accordingly, the operation range in the low-temperature environment can be expanded.

In the example, the air conditioning controller 32 performs the heating operation while switching the respective modes based on a request temperature control object cooling capability Qbat requested for the refrigerant-heat medium heat exchanger 64; therefore, both the heating of the cabin and the cooling of the battery 55 can be achieved as appropriate.

In addition, in the example, in the case where the predetermined starting condition is satisfied after the operation starts in the external air heat absorption heating mode or the combination heating mode, the air conditioning controller 32 performs any of the modes selected based on the request temperature control object cooling capability Qbat. Thus, the refrigerant remaining in the outdoor heat exchanger 7 or the like can be collected at the start without any trouble, and then, the mode can smoothly shift to the suitable mode selected based on the request temperature control object cooling capability Qbat.

In particular, in the example, the starting condition is that the predetermined time has elapsed after start, the refrigerant sucking pressure of the compressor 2 has decreased to be lower than or equal to the predetermined value and the predetermined time has elapsed, and the refrigerant sucking temperature of the compressor 2 has decreased to be lower than or equal to the predetermined value and the predetermined time has elapsed. Therefore, the refrigerant remaining in the outdoor heat exchanger 7 or the like can be collected for sure, and then, the mode can shift to the suitable mode.

In the example, the vehicle air conditioning device 1 can perform the three modes of the external air heat absorption heating mode, the combination heating mode, and the temperature control object heat absorption heating mode in the heating operation; however, the invention according to claim 1 is also effective in the vehicle air conditioning device that can perform two modes of the external air heat absorption heating mode and the temperature control object heat absorption heating mode, and the invention according to claim 3 is also effective in the vehicle air conditioning device that can perform two modes of the combination heating mode and the temperature control object heat absorption heating mode.

In addition, the structure of the air conditioning controller 32 and the structure of the refrigerant circuit R of the vehicle air conditioning device 1 are not limited to the aforementioned structures, and can be changed within the scope not departing from the concept of the present invention. In particular, the temperature control object mounted in the vehicle in the example is the battery 55; however, the temperature control object is not limited to the battery 55 and may be the travel motor or the like.

Furthermore, in the example of the present invention, the heat medium is cooled by the refrigerant using the refrigerant-heat medium heat exchanger 64 and this heat medium is circulated in the battery 55, which is the temperature control object, so that the battery 55 is cooled in the apparatus temperature adjustment device 61; however, the temperature control object (battery 55 or the like) may be cooled directly by the refrigerant. In this case, the temperature sensor that detects the temperature of the temperature control object (in the example, battery 55) is provided and the temperature of the temperature control object is detected directly.

### LIST OF THE REFERENCE NUMERALS

1 Vehicle air conditioning device

2 Compressor

4 Radiator (indoor heat exchanger)

6 Outdoor expansion valve

7 Outdoor heat exchanger

8 Indoor expansion valve

9 Heat sink

32 Air conditioning controller (control device)

55 Battery (temperature control object)

61 Apparatus temperature adjustment device

62 Circulation pump

64 Refrigerant-heat medium heat exchanger (temperature control object heat exchanger)

73 Auxiliary expansion valve

What is claimed is:

1. A vehicle air conditioning device for performing air conditioning in a cabin, the vehicle air conditioning device comprising:
a compressor that compresses a refrigerant;
an indoor heat exchanger that performs heat exchange between air to be supplied into the cabin and the refrigerant;
an outdoor heat exchanger that is provided outside the cabin;
a control device; and
a temperature control object heat exchanger that adjusts temperature of a temperature control object mounted in a vehicle by using the refrigerant, wherein
the control device performs heating operation for heating the cabin using the indoor heat exchanger,
the heating operation includes
an external air heat absorption heating mode for heating the cabin in a manner that the refrigerant discharged from the compressor radiates heat in the indoor heat exchanger, the refrigerant having radiated heat is decompressed, and then the refrigerant absorbs heat in the outdoor heat exchanger, and
a temperature control object heat absorption heating mode for heating the cabin in a manner that the refrigerant discharged from the compressor radiates heat in the indoor heat exchanger, the refrigerant having radiated heat is decompressed, and then the refrigerant absorbs heat in the temperature control object heat exchanger and these modes are performed while being switched, and
the heating operation is started in the external air heat absorption heating mode.

2. The vehicle air conditioning device according to claim 1, wherein
in the heating operation, the control device further performs a combination heating mode for heating the cabin in a manner that the refrigerant discharged from the compressor radiates heat in the indoor heat exchanger, the refrigerant having radiated heat is decompressed, and then the refrigerant absorbs heat in the outdoor heat exchanger and the temperature control object heat exchanger,
the control device performs the heating operation while switching among the external air heat absorption heating mode, the combination heating mode, and the temperature control object heat absorption heating mode, and
the heating operation is started in the external air heat absorption heating mode or the combination heating mode.

3. A vehicle air conditioning device for performing air conditioning in a cabin, the vehicle air conditioning device comprising:
a compressor that compresses a refrigerant;
an indoor heat exchanger that performs heat exchange between air to be supplied into the cabin and the refrigerant;
an outdoor heat exchanger that is provided outside the cabin;
a control device; and
a temperature control object heat exchanger that adjusts temperature of a temperature control object mounted in a vehicle by using the refrigerant, wherein
the control device performs heating operation for heating the cabin using the indoor heat exchanger,
the heating operation includes
a temperature control object heat absorption heating mode for heating the cabin in a manner that the refrigerant discharged from the compressor radiates heat in the indoor heat exchanger, the refrigerant having radiated heat is decompressed, and then the refrigerant absorbs heat in the temperature control object heat exchanger, and
a combination heating mode for heating the cabin in a manner that the refrigerant discharged from the compressor radiates heat in the indoor heat exchanger, the refrigerant having radiated heat is decompressed, and then the refrigerant absorbs heat in the outdoor heat exchanger and the temperature control object heat exchanger, and these modes are performed while being switched, and
the heating operation is started in the combination heating mode.

4. The vehicle air conditioning device according to claim 1, wherein the control device performs the heating operation while switching the respective modes based on a request temperature control object cooling capability requested for the temperature control object heat exchanger.

5. The vehicle air conditioning device according to claim 4, wherein in a case where a predetermined starting condition is satisfied after the operation starts in the external air heat absorption heating mode, the external air heat absorption heating mode or the combination heating mode, or the combination heating mode, the control device performs any of the modes selected based on the request temperature control object cooling capability.

6. The vehicle air conditioning device according to claim 5, wherein the starting condition is one of the following conditions, a combination of the following conditions, or all of the following conditions: a predetermined time has elapsed after start, a refrigerant sucking pressure of the compressor has decreased to be lower than or equal to a predetermined value and a predetermined time has elapsed, a refrigerant sucking temperature of the compressor has decreased to be lower than or equal to a predetermined value and a predetermined time has elapsed.
